(19) United States
(12) Patent Application Publication
(10) Pub. No.: US 2016/0240105 A1
(43) Pub. Date: Aug. 18, 2016

(54) Tooth Anatomy Model and Demonstration Method

(71) Applicant: COLGATE-PALMOLIVE COMPANY, New York, NY (US)

(72) Inventors: Neelima Utgikar, Maharashtra (IN); Ravi Subramanyam, Belle Mead, NJ (US); Shashank Potnis, Thane (W) (IN); Nikhill Kheur, Mumbai (IN)

(73) Assignee: COLGATE-PALMOLIVE COMPANY, New York, NY (US)

(21) Appl. No.: 15/028,063

(22) PCT Filed: Oct. 9, 2014
(86) PCT No.: PCT/US14/59907

§ 371 Date: Apr. 8, 2016

(30) Foreign Application Priority Data
Oct. 9, 2013 (IN) 3012/DEL/2013

(51) Int. Cl. G09B 23/28; G09B 5/02

(52) U.S. Cl. CPC G09B 23/283; G09B 5/02

(57) ABSTRACT

The present application provides a tooth anatomy model comprising: a first layer representing tooth dentin, said first layer being made of a first material; and a sensor system associated with a surface of the first layer, which system is adapted to sense at least one of temperature and air pressure. The present application also provides a method of demonstrating tooth hypersensitivity using a tooth anatomy model.

### BACKGROUND

Various dental models have been used for the purposes of training and education, for example to demonstrate enamel loss and gum recession; to illustrate dental procedures such as root canal and dental implant procedures; and to teach proper brushing techniques for the maintenance of good oral hygiene.

It would be desirable to provide a tooth anatomy model and demonstration method which can be used to educate consumers about the processes involved in dental hypersensitivity, and also to illustrate the reduction in hypersensitivity as provided by oral care compositions having anti-hypersensitivity activity.

### BRIEF SUMMARY

The present application relates to a tooth anatomy model, and to a method of demonstrating tooth hypersensitivity using a tooth anatomy model.

In one aspect, the present invention provides a tooth anatomy model comprising: a first layer representing tooth dentin, said first layer being made of a first material; and a sensor system associated with a surface of the first layer, which system is adapted to sense at least one of temperature and air pressure.

Optionally, the first material is a cellular foam.

Optionally, the first material is a thermoplastic material.

Optionally, the first material is blown polystyrene.

Optionally, the first material is fiber-reinforced plastic.

Optionally, the surface of the first layer is an outer surface of the first layer.

Optionally, the sensor system is positioned on the surface of the first layer.

Optionally, the tooth anatomy model further comprises a second layer covering the sensor system and the surface of the first layer, wherein the second layer is made of a second material and comprises channels extending from the sensor system to a surface of the second layer.

Optionally, the second material is a paint.

Optionally, the second layer has a thickness of from 0.5 mm to 5 mm.

Optionally, the surface of the second layer is an outer surface of the second layer.

Optionally, the sensor system comprises at least one thermal sensor.

Optionally, the sensor system comprises at least one air pressure sensor.

Optionally, the model further comprises at least one signal generator for generating at least one signal selected from an audio signal and a visual signal, wherein the sensor system is adapted to activate the at least one signal generator upon sensing a change in temperature or air pressure.

Optionally, the sensor system comprises at least one thermal sensor which is adapted to activate the at least one signal generator upon sensing a temperature of below about 23° C.; further optionally below about 19° C.; still further optionally below about 15° C.

Optionally, the sensor system comprises at least one thermal sensor which is adapted to activate the at least one signal generator upon sensing a temperature of above about 28° C.; further optionally above about 31° C.; still further optionally above about 35° C.

Optionally, the signal generator comprises at least one light source. Further optionally, the at least one light source comprises at least one LED.

Optionally, the signal generator comprises at least one audio source. Further optionally, the audio source comprises a buzzer.

Optionally, the signal generator comprises at least one light source which is positioned in a portion of the tooth anatomy which represents a tooth pulp cavity. Further optionally, the at least one light source comprises at least one LED.

Optionally, the sensor system is adapted to activate the signal generator so as to activate the at least one light source positioned in the portion of the tooth anatomy model representing the tooth pulp cavity upon sensing a change in temperature.

Optionally, the sensor system is adapted to activate the signal generator so as to activate the at least one light source positioned in the portion of the tooth anatomy model representing the tooth pulp cavity upon sensing a change in air pressure. Alternatively, the signal generator further comprises a light source positioned on a portion of the tooth anatomy model which represents tooth enamel, and the sensor system is adapted to activate the signal generator so as to activate the at least one light source positioned on the portion of the tooth anatomy model representing dental enamel upon sensing a change in air pressure.

Optionally, the light source positioned on the portion of the tooth anatomy model representing tooth enamel comprises at least one LED.

Optionally, the model further comprises a portion representing a tooth pulp cavity.

Optionally, the model further comprises a portion representing tooth enamel.

Optionally, the model further comprises a portion representing dental cementum.

Optionally, the model further comprises at least one portion representing gingiva. Further optionally, at least one of the portions representing gingiva is a portion representing receding gingiva.

Optionally, the model further comprises at least one portion representing alveolar bones.

Optionally, the model further comprises a portion representing nerves in the tooth pulp cavity.

Optionally, the model has a height of from about 10.2 cm (4 inches) to about 66.0 cm (26 inches); further optionally from about 25.4 cm (10 inches) to about 55.9 cm (22 inches); still further optionally from about 40.6 cm (16 inches) to about 45.7 cm (18 inches).

In a second aspect, the present invention provides a method of demonstrating tooth hypersensitivity using a tooth anatomy model, the method comprising: contacting a first layer representing tooth dentin with at least one stimulus selected from a heat stimulus and an air pressure stimulus; wherein the tooth anatomy model is adapted to sense the at least one stimulus and to provide at least one signal selected from an audio signal and a visual signal upon sensing of the at least one stimulus.

Optionally, the surface layer is made of a first material.

Optionally, the first material is a cellular foam.

Optionally, the first material is a thermoplastic material.

Optionally, the first material is blown polystyrene.

Optionally, the first material is fiber-reinforced plastic.

Optionally, the method further comprises the steps of: applying an oral care composition to the first layer representing tooth dentin; thereafter, contacting the first layer representing tooth dentin with at least one stimulus selected from a heat stimulus and an air pressure stimulus; wherein the oral care composition prevents the tooth anatomy model from sensing the at least one stimulus.

Optionally, a second layer covers the first layer, wherein the second layer is made of a second material and comprises channels extending from the first layer to a surface of the second layer.

Optionally, the surface of the second layer is an outer surface of the second layer.

Optionally, the second material is a paint.

Optionally, the second layer has a thickness of from 0.5 mm to 5 mm.

Optionally, the method further comprises the steps of: applying an oral care composition to the second layer; thereafter, contacting the second layer with at least one stimulus selected from a heat stimulus and an air pressure stimulus, wherein the oral care composition prevents the tooth anatomy model from sensing the at least one stimulus.

Optionally, the at least one signal comprises a visual signal.

Optionally, the visual signal comprises illumination of a light source. Further optionally, the light source comprises at least one LED.

Optionally, the at least one signal comprises an audio signal. Further optionally, the audio signal comprises sounding of a buzzer.

Optionally, the stimulus comprises a thermal stimulus.

Optionally, the thermal stimulus is a temperature of below about 23° C.; further optionally below about 19° C.; still further optionally about 15° C.

Optionally, the thermal stimulus is a temperature of above about 28° C.; further optionally above about 31° C.; still further optionally above about 35° C.

Optionally, the stimulus comprises a change in air pressure.

Optionally, the visual signal comprises illumination of at least one light source which is positioned in a portion of the tooth anatomy model representing the tooth pulp cavity. Still further optionally, the at least one light source comprises at least one LED.

Optionally, the at least one stimulus comprises a thermal stimulus, and the tooth anatomy model is adapted to illuminate the at least one light source positioned in the portion of the tooth anatomy model representing the tooth pulp cavity upon sensing of the thermal stimulus.

Optionally, the at least one stimulus comprises an air pressure stimulus, and the tooth anatomy model is adapted to illuminate the at least one light source positioned in the portion of the tooth anatomy model representing the tooth pulp cavity upon sensing of the air pressure stimulus. Alternatively, the visual signal further comprises illumination of a light source positioned on a portion of the tooth anatomy model which represents tooth enamel, and the tooth anatomy model is adapted to illuminate the light source positioned on the portion of the tooth anatomy model representing tooth enamel upon sensing of the air pressure stimulus.

Optionally, the light source positioned on the portion of the tooth anatomy model which represents tooth enamel comprises at least one LED.

Optionally, the tooth anatomy model further comprises a portion representing a tooth pulp cavity.

Optionally, the tooth anatomy model further comprises a portion representing tooth enamel.

Optionally, the tooth anatomy model further comprises a portion representing dental cementum.

Optionally, the tooth anatomy model further comprises at least one portion representing gingiva. Further optionally, at least one of the portions representing gingiva is a portion representing receding gingiva.

Optionally, the tooth anatomy model further comprises at least one portion representing alveolar bones.

Optionally, the tooth anatomy model further comprises a portion representing nerves in the tooth pulp cavity.

Optionally, the tooth anatomy model has a height of from about 10.2 cm (4 inches) to about 66.0 cm (26 inches); further optionally from about 25.4 cm (10 inches) to about 55.9 cm (22 inches); still further optionally from about 40.6 cm (16 inches) to about 45.7 cm (18 inches).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a tooth anatomy model in accordance with an embodiment of the present invention, showing an external view of the model.

FIG. 2 illustrates a tooth anatomy model in accordance with an embodiment of the present invention, showing the location of the sensor system and showing at least one light source positioned in the portion representing the tooth pulp cavity.

FIG. 3 illustrates the tooth anatomy model as shown in FIG. 2, with an additional light source positioned on top of the tooth, on an area representing tooth enamel.

FIG. 4 is a schematic illustration (not to scale) of the second layer covering the sensor system and the surface of the first layer, showing the channels in the second layer, in accordance with an embodiment of the present invention.

FIG. 5 is a schematic representation of the arrangement of the thermal sensor, the controller, and the signal generator (which in this embodiment generates a visual signal) in a tooth anatomy model according to an embodiment of the present invention.

FIG. 6 is a schematic representation of the arrangement of the air pressure sensor (which is a differential pressure switch in the illustrated embodiment) and the signal generator (which in this embodiment generates both a visual signal and an audio signal) in a tooth anatomy model according to an embodiment of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

Unless otherwise indicated, all procedures are carried out at an ambient room temperature of approximately 25° C.

The present invention provides a tooth anatomy model and a method of demonstrating tooth hypersensitivity using a tooth anatomy model. In one embodiment, the method further illustrates the reduction or elimination of hypersensitivity as provided by application to the tooth of an oral care composition having anti-hypersensitivity activity.

The present invention provides a tooth anatomy model comprising: a first layer 12 representing tooth dentin, said first layer 12 being made of a first material; and a sensor system associated with a surface of the first layer 12, which system is adapted to sense at least one of temperature and air pressure.

In one embodiment, the first material is a cellular foam. In various embodiments, the first material is a thermoplastic material. In one embodiment, the first material is blown polystyrene. A non-limiting example of a blown polystyrene material suitable as the surface layer is Thermocol. In another embodiment, the first material is fiber-reinforced plastic (FRP).

In various embodiments, the surface of the first layer is an outer surface 28 of the first layer 12.

In various embodiments, the sensor system is positioned on the surface of the first layer 12.

In one embodiment, the tooth anatomy model further comprises a second layer 46, covering the sensor system and the surface of the first layer 12. The second layer 46 is made of a second material and comprises channels 48 extending from the sensor system to a surface of the second layer 46. In some embodiments, the surface of the second layer 46 is an outer surface 60 of the second layer 46. The presence of the channels 48 allows for the sensor system to be in communication with the air surrounding the model, and thus allows for a change in the air temperature or the air pressure at the outer surface 60 of the second layer 46 to be communicated through the channels 48 to the sensor system. The channels are also a representation of dentinal tubules.

In one embodiment, the second material is a paint. Any paint may be used, provided that it is compatible with the first material e.g. does not cause the first material to dissolve. Suitable paints which may be used include oil paints and/or water-based paints.

In one embodiment, the sensor system comprises at least one thermal sensor 34. A non-limiting example of a thermal sensor 34 which may be used in the present invention is a RTD (resistance temperature device) type model PT100. In some embodiments, as the PT100 sensor is very small in size as compared to the size of the tooth anatomy model (in which the surface area exposed to the change in temperature is relatively large), this sensor can be sandwiched between two thin metal sheets before being inserted into the tooth anatomy model.

In various embodiments, the sensor system comprises at least one air pressure sensor 36. A non-limiting example of an air pressure sensor 36 which may be used in the present invention is a Differential Pressure (DP) switch, such as those marketed by World Magnetics (e.g. World Magnetics' DesignFLEX™ PSF102 series). The Differential Pressure switch may be an integrated device, i.e. a sensor with a built-in switch. In some embodiments the DP sensor is based on a diaphragm principle. Blowing air onto the DP sensor results in a pressure difference across the sensor, with high pressure being created on one side and low pressure being created on the other side. The creation of the pressure differential activates the built-in switch (which, in certain embodiments, activates the at least one signal generator). Such DP switches have a pressure set point 52, which is adjustable within a certain pressure range. For example, for one option in the World Magnetics DesignFLEX™ PSF102 series, the adjustable set point range may be selected to be from 0.1″ to 0.5″ H₂O (from 0.004 to 0.018 psi).

In some embodiments, the second layer 46 has a thickness of from 0.5 min to 5 mm; from 1 mm to 4 mm; from 1.5 mm to 3 mm; or of about 2 mm. In some embodiments, the sensors of the sensor system are arranged so that their surfaces are flush with the outer surface 28 of the first layer 12 (which is made of the first material). In these embodiments, the sensors of the sensor system are therefore located at a depth of from 0.5 mm to 5 mm; from 1 mm to 4 mm; from 1.5 mm to 3 mm; or of about 2 mm beneath the outer surface 60 of the second layer.

In various embodiments, the model further comprises at least one signal generator for generating at least one signal selected from an audio signal and a visual signal, wherein the sensor system is adapted to activate the at least one signal generator upon sensing a change in temperature or air pressure.

In various embodiments, the sensor system comprises at least one thermal sensor 34 which is adapted to activate the at least one signal generator upon sensing a temperature of below about 23° C., below about 22° C., below about 21° C., below about 20° C., below about 19° C., below about 18° C., below about 17° C., below about 16° C., or below about 15° C. In some embodiments, the sensor system comprises at least one thermal sensor 34 which is adapted to activate the at least one signal generator upon sensing a temperature of above about 28° C., above about 29° C., above about 30° C., above about 31° C., above about 32° C., above about 33° C., above about 34° C., or above about 35° C. In some embodiments, the thermal sensor 34 is adapted to activate the at least one signal generator upon sensing a temperature of below about 23° C. or above about 28° C.; of below about 22° C. or above about 29° C.; of below about 21° C. or above about 30° C.; of below about 19° C. or above about 31° C.; of below about 18° C. or above about 32° C.; of below about 17° C. or above about 33° C.; of below about 16° C. or above about 34° C.; or of below about 15° C. or above about 35° C.

In some embodiments, the at least one thermal sensor 34 is connected to a controller 50, which controller 50 is adapted to activate the at least one signal generator when the thermal sensor 34 senses a temperature of below about 23° C., below about 22° C., below about 21° C., below about 20° C., below about 19° C., below about 18° C., below about 17° C., below about 16° C., or below about 15° C.

In some embodiments, the at least one thermal sensor 34 is connected to a controller 50, which controller 50 is adapted to activate the at least one signal generator when the thermal sensor 50 senses a temperature of above about 28° C., above about 29° C., above about 30° C., above about 31° C., above about 32° C., above about 33° C., above about 34° C., or above about 35° C.

In some embodiments, the sensor system comprises at least one thermal sensor 34 connected to a controller 50, which controller 50 is adapted to activate the at least one signal generator when the thermal sensor 34 senses a temperature of below about 23° C. or above about 28° C.; of below about 22° C. or above about 29° C.; of below about 21° C. or above about 30° C.; of below about 19° C. or above about 31° C.; of below about 18° C. or above about 32° C.; of below about 17° C. or above about 33° C.; of below about 16° C. or above about 34° C.; or of below about 15° C. or above about 35° C.

In some embodiments, the signal generator comprises at least one light source. In various embodiments, the at least one light source comprises at least one LED.

In some embodiments, the signal generator comprises at least one audio source, in various embodiments, the audio source comprises a buzzer 54.

In various embodiments, the model further comprises a portion representing a tooth pulp cavity 16.

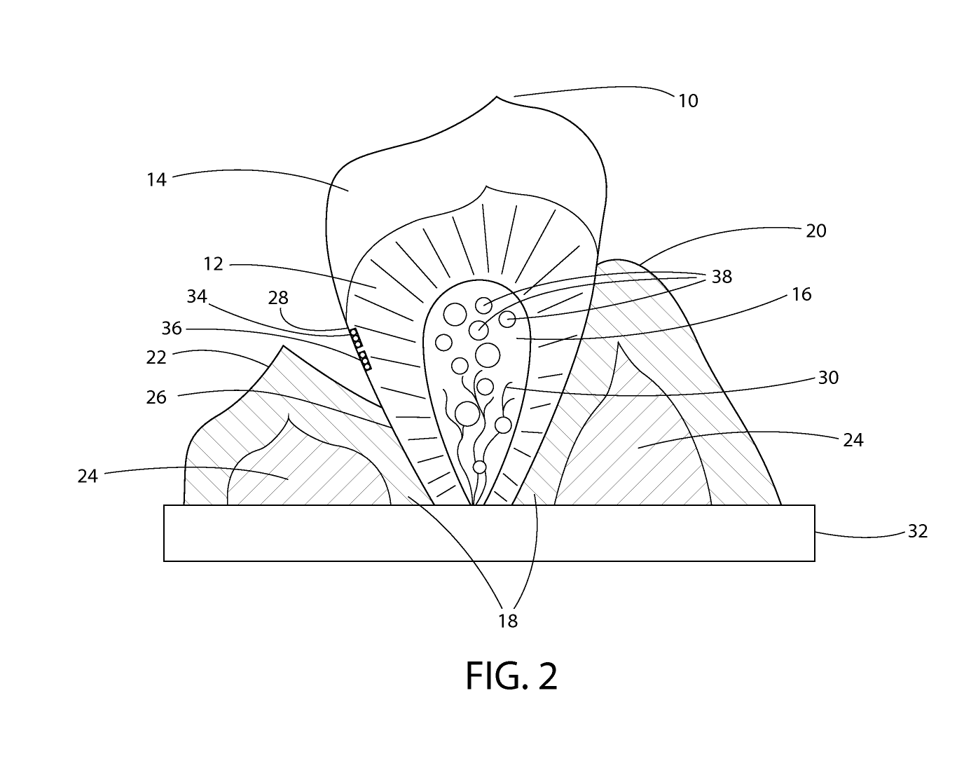

In some embodiments, the signal generator comprises at least one light source which is positioned in the portion representing the tooth pulp cavity 16, as illustrated in FIG. 2. In various embodiments, the at least one light source comprises at least one LED 38. In some embodiments the light source is a source of colored light, for example (but not limited to) red light. In other embodiments, the light source is a source of white light. In some embodiments where the light source is a source of white light, the portion representing the tooth pulp cavity 16 further comprises a colored filter covering the light source, for example a red filter such as red gelatin paper. In various embodiments, filters of other colors could be used. In various embodiments, the at least one light source as discussed above comprises at least one LED 38. In various embodiments, the sensor system is adapted to activate the signal generator so as to activate the at least one light source positioned in the portion of the tooth anatomy model representing the tooth pulp cavity 16, upon sensing a change in temperature. In some embodiments, the sensor system is adapted to activate the signal generator so as to activate the at least one light source positioned in the portion of the tooth anatomy model representing the tooth pulp cavity 16, upon sensing a change in air pressure.

In various embodiments, the plurality of light sources positioned in the portion representing a tooth pulp cavity 16, when activated, light up so as to provide constant illumination. In other embodiments, upon activation, the plurality of light sources provides intermittent illumination e.g. flashing on and off. For example, in one embodiment, the light sources may flash on and off in such a way that all the light sources are illuminated at the same time as one another. In another embodiment, the light sources run flash on and off in a sequence such that approximately only half of the light sources are illuminated at any one time. In another embodiment, the light sources may be sequenced so as to flash on and off consecutively.

In some embodiments, the model further comprises a portion representing tooth enamel 14.

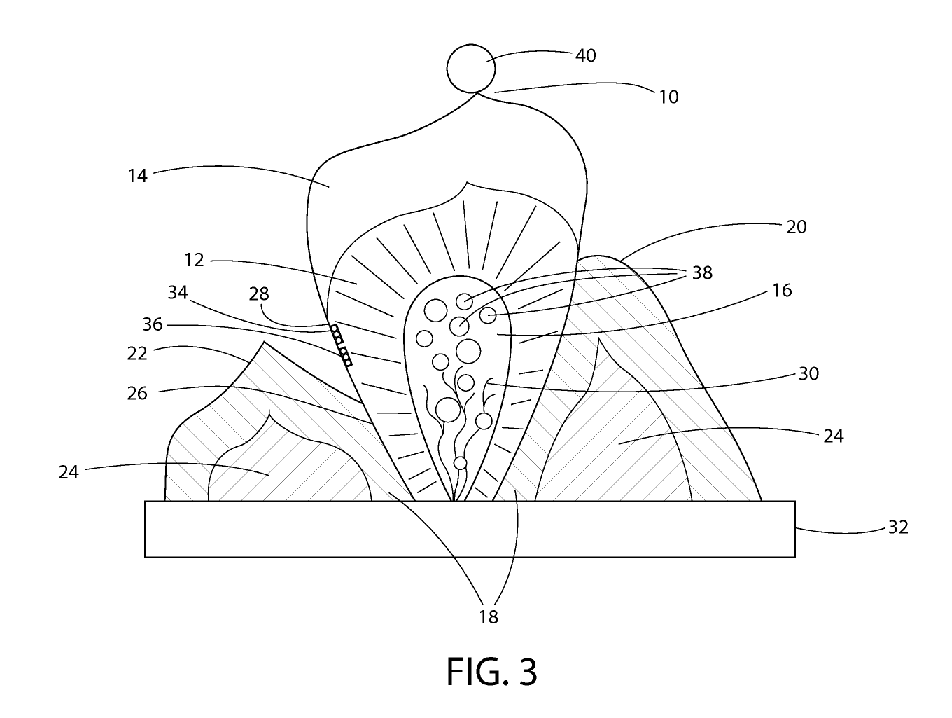

In various embodiments, the tooth anatomy model comprises at least one light source located on a portion representing tooth enamel 14, as illustrated in FIG. 3. In these embodiments, the sensor system is adapted to activate the signal generator so as to activate the at least one light source positioned on the portion of the tooth anatomy model representing tooth enamel upon sensing a change in air pressure. In various embodiments, this light source is a white light source. In some embodiments, this light source is an LED 40. In certain embodiments, this light source is activated when the air pressure sensor 36 senses a change in air pressure, while the at least one light source positioned in the portion representing the tooth pulp cavity 16 is activated when the thermal sensor 34 senses a change in temperature.

In some embodiments, the model further comprises a portion representing dental cementum 26. In some embodiments, the model further comprises at least one portion representing gingiva 18. Typically, at least one of the portions representing gingiva is a portion representing receding gingiva 22. The portion representing dental cementum 26 is typically disposed between the portion representing dentin 12 and the portion representing gingiva 18, with the surface of the dentin exposed by the receding gingiva being free of dental cementum.

In some embodiments, the model further comprises at least one portion representing alveolar bones 24.

In some embodiments, the model further comprises a portion representing nerves in the tooth pulp cavity 30.

In some embodiments, the model has a height of from about 10.2 cm (4 inches) to about 66.0 cm (26 inches); from about 15.24 cm (6 inches) to about 63.5 cm 25 inches); from about 20.32 cm (8 inches) to about 60.96 cm (24 inches); from about 25.4 cm (10 inches) to about 55.9 cm (22 inches); from about 30.48 cm (12 inches) to about 50.8 cm (20 inches); from about 35.56 cm (14 inches) to about 48.26 cm (19 inches); or from about 40.6 cm (16 inches) to about 45.7 cm (18 inches).

The present invention also provides a method of demonstrating tooth hypersensitivity using a tooth anatomy model, the method comprising: contacting a first layer representing tooth dentin with at least one stimulus selected from a heat stimulus and an air pressure stimulus; wherein the tooth anatomy model is adapted to sense the at least one stimulus and to provide at least one signal selected from an audio signal and a visual signal upon sensing of the at least one stimulus.

In various embodiments, the tooth anatomy model is a tooth anatomy model as described in any of the embodiments discussed above.

In some embodiments, the method further comprises the steps of: applying an oral care composition to the first layer representing tooth dentin; thereafter, contacting the first layer representing tooth dentin with at least one stimulus selected from a heat stimulus and an air pressure stimulus; wherein the oral care composition prevents the tooth anatomy model from sensing the at least one stimulus. In some embodiments, the oral care composition is a composition which is effective in blocking dentinal tubules of a tooth.

In some embodiments, a second layer covers the first layer, wherein the second layer is made of a second material and comprises channels extending from the first layer to a surface of the second layer. In some embodiments, the method further comprises the steps of applying an oral care composition to the second layer; thereafter, contacting the second layer with at least one stimulus selected from a heat stimulus and an air pressure stimulus, wherein the oral care composition prevents the tooth anatomy model from sensing the at least one stimulus.

It is noted that the tooth anatomy model and the uses described herein are applicable both to humans and/or animals.

In a further embodiment of the invention, the density of the tubules in the tooth is a density selected from the group consisting of less than 10,000 tubules/mm², less than 5,000 tubules/mm² and less than 2,000 tubules/mm².

In a further embodiment of the invention, the density of the tubules in the tooth is a density selected from the group consisting of greater than 100 tubules/mm², greater than 250 tubules/mm² and greater than 500 tubules/mm².

Embodiments of the present invention are further described in the following examples. The examples are merely illustrative and do not in any way limit the scope of the invention as described and claimed.

### EXAMPLES

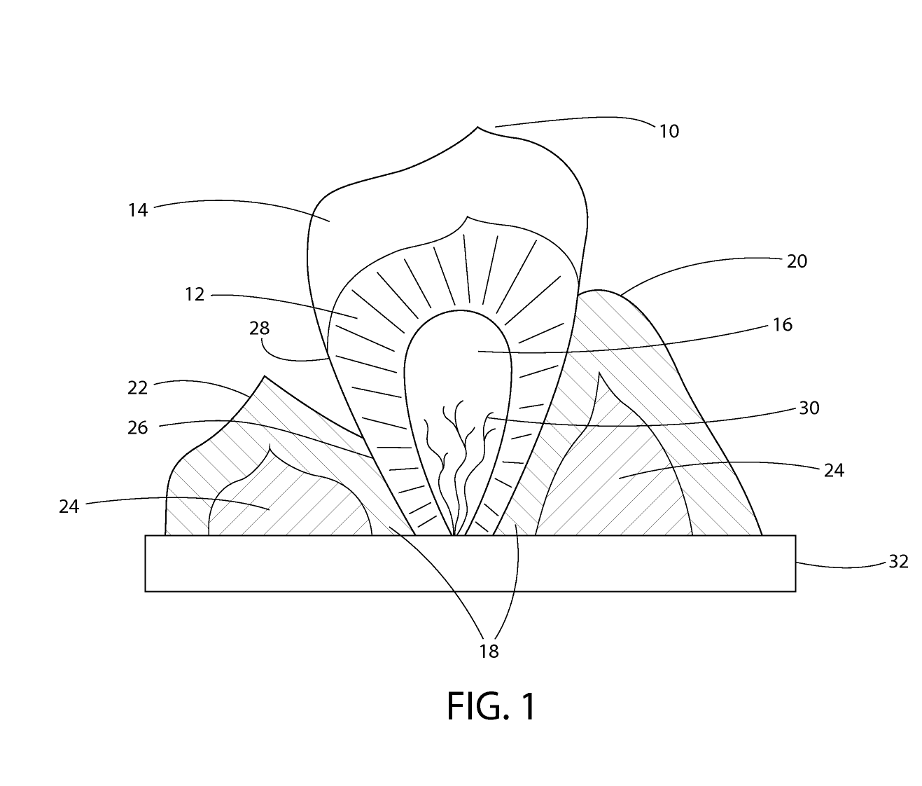

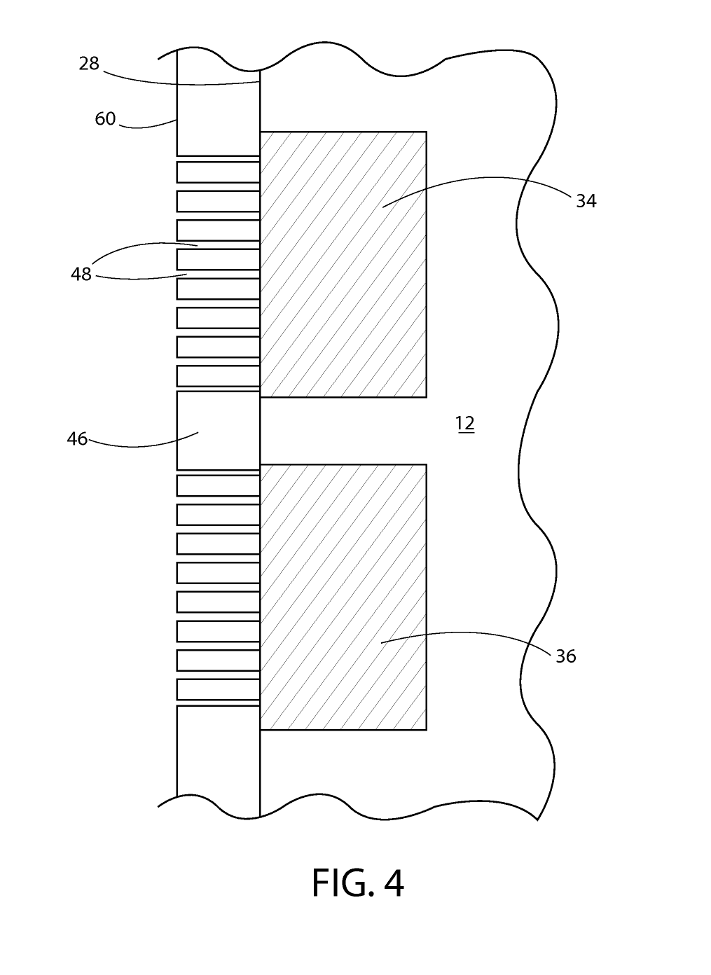

In an illustrative, but non-limiting, example of the tooth anatomy model and method, the tooth anatomy model 10—as illustrated in FIGS. 1, 2 and 4 (FIG. 4 showing the layer 46 of paint)—comprises a portion representing tooth dentin 12, a portion representing tooth enamel 14, a portion representing a tooth pulp cavity 16, a portion representing gingiva 18 (including a portion representing normal, non-receding gingiva 20, and a portion representing receding gingiva 22), a portion representing alveolar bones 24, a portion representing dental cementum 26 and a portion representing nerves in the tooth pulp cavity 30. The portion representing dental cementum 26 is disposed between the portion representing dentin 12 and the portion representing gingiva 18. Where the gingiva is shown as being receding, thus exposing the tooth dentin, there is no dental cementum present on the surface 28 of the exposed portion of dentin. This represents the dental cementum having been eroded and removed from the area exposed by the receding gingiva 22. The tooth anatomy model 10 is constructed of Thermocol, and is mounted on a wooden platform 32. The model is painted with oil paints so as to provide the various portions with an appearance consistent with that of an actual tooth and associated structures (such as gingiva and alveolar bones). The model is sprayed with the oil paint 3 to 4 times, so that the layer of paint is about 2 mm thick. The model is approximately 45.7 cm (118 inches) high and 45.7 cm (18 inches) wide.

As schematically illustrated in FIG. 2, the tooth anatomy model 10 comprises a thermal sensor 34 and an air pressure sensor 36. As schematically illustrated in FIG. 4, both the thermal sensor 34 and the air pressure sensor 36 are located on the outer surface 28 of the portion representing dentin 12, but beneath the layer 46 of paint. In the illustrated embodiment, the surfaces of the air pressure sensor 36 and the thermal sensor 34 are flush with the outer surface 28 of the portion representing dentin 12. Channels 48 are made in the paint layer 46 in the area of the model where the thermal sensor 34 and the air pressure sensor 36 are located, and these channels 48 extend from the sensors 34, 36 to the outer surface 60 of the paint layer 46. These channels 48 allow heat and air pressure at the exterior of the model to be communicated to the sensors 34, 36 beneath the paint layer 46. The channels 48 are a representation of dentinal tubules.

As illustrated in FIG. 2, a plurality of LEDs 38 are positioned in the portion representing the tooth pulp cavity 20. Although not illustrated in FIG. 2, the LEDs 38 are white LEDs wrapped in red gelatin paper as a colored filter.

Although not illustrated in FIG. 2, the tooth anatomy model 110 further comprises a buzzer (not shown).

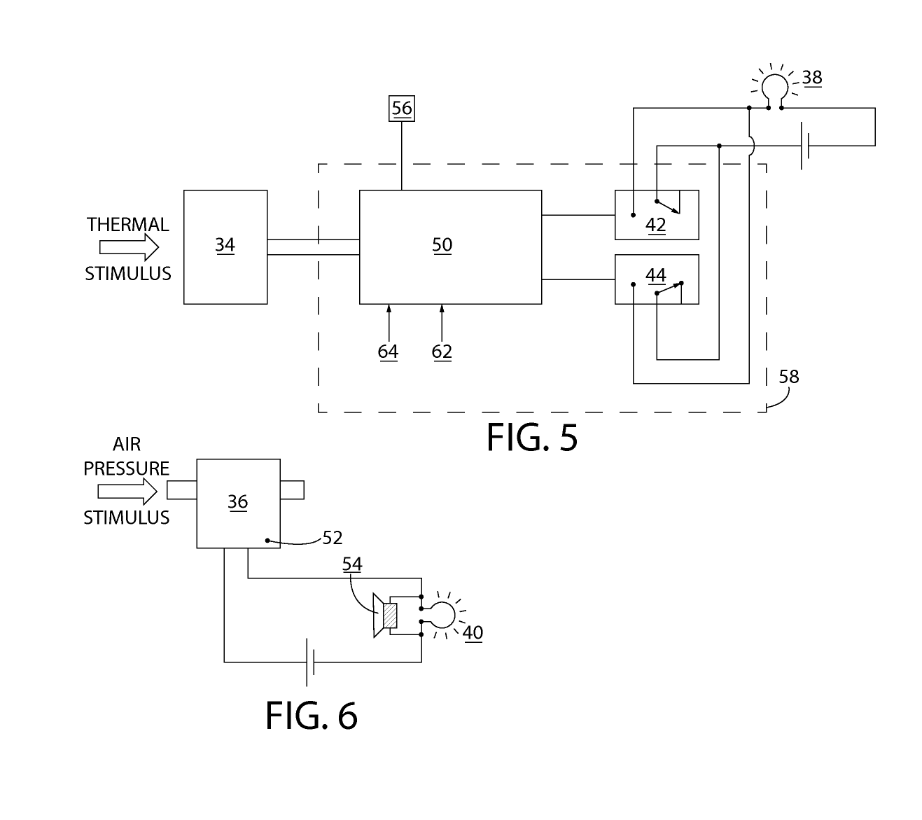

In the embodiment illustrated in FIG. 2, the thermal sensor 34 is an RTD type (resistance temperature device) model PT100, sandwiched between two metal sheets. The size of this assembly is approximately 1.5 cm×1.5 cm. As illustrated schematically in FIG. 5, the thermal sensor 34 is connected to a controller 50. The controller 50 is configured so that any temperature increase above 28° C. detected by the thermal sensor 34 results in activation of a first relay switch 42 (which configuration is carried out by manually inputting 62 the temperature above which the first relay switch 42 is to be activated, using the keys on the front of the controller), and any temperature decrease below 23° C. detected by thermal sensor 34 results in activation of a second relay switch 44 (the configuration of the controller 50 being carried out by manually inputting 64 the temperature below which the second relay switch 44 is to be activated, using the keys on the front of the controller). The controller 50 and first 42 and second 44 relay switches are contained in an enclosure 58, and the controller is connected to a power source 56. As illustrated in FIG. 5, the output of the first and second relay switches 42, 44 is in parallel. Therefore, activation of either the first 42 or the second 44 relay switch results in illumination of the LEDs 38. Although not illustrated in FIG. 5, a buzzer is also connected in parallel to the LEDs 38 (in an arrangement analogous to that shown in FIG. 6). The buzzer therefore sounds when either the first 42 or second relay switch 44 is activated.

Although not illustrated in FIG. 5, the air pressure sensor 36 is also connected to the LEDs 38 and to the buzzer, and is configured to light up the LEDs 38 and to sound the buzzer if it senses a change in air pressure. In this embodiment, the air pressure sensor is a PSF102 series Differential Pressure switch from World Magnetics, in which the Low Port/Housing is a barbed port for 3/16″ (0.48 cm) ID tubing without mounting tugs, the High Port/Cover is a barbed port for 3/16″ (0.48 cm) ID tubing, the diaphragm is Teflon, and the Adjustable Set Point Range is 0.1″ to 0.5″ H₂O (0.004 to 0.018 psi). This DP switch (as illustrated in The Set Point is manually input into the DP switch (as illustrated at 52 in FIG. 6). As discussed above, blowing air onto the DP switch results in a pressure difference across the sensor, with high pressure being created on one side and low pressure being created on the other side. As the DP switch in this embodiment is an integrated device, i.e. a sensor with a built-in switch, the creation of this pressure differential activates the switch, resulting in illumination of the LEDs 38 and sounding of the buzzer. In this embodiment, the output of the differential pressure switch is connected in parallel to the outputs of the first 42 and second 44 relay switches. Therefore, activation of either the first 42 or second 44 relay switch or of the differential pressure switch 36 results in illumination of the LEDs 38 and sounding of the buzzer.

As schematically illustrated in FIG. 3, in another embodiment the tooth anatomy model 10 further comprises a white LED 40 positioned on the portion representing tooth enamel 14 at the top of the tooth model 10. In this embodiment, the LEDs 38 positioned in the portion representing the tooth pulp cavity 16 are connected to the relay switches 42, 44 only, and the white LED 40 is connected to the differential pressure switch 36. Therefore, if the temperature drops below 23° C. or rises above 28° C., the LEDs 38 are illuminated and, if the differential pressure switch 36 senses a pressure differential, the white LED 40 is illuminated. The illumination of the LEDs 38 and the LED 40 is illustrated in FIGS. 5 and 6 (in which FIG. 6 shows the Differential Pressure switch with Set Point 52). A first buzzer may also be connected in parallel to the LED 38, and a second buzzer 54 may be connected parallel to the LED 40. Therefore, the buzzers are sounded as the LEDs 38, 40 are illuminated. Alternatively, a single buzzer may be connected in parallel to both the LED 38 and the LED 40.

An illustrative, but non-limiting, example of the method using the tooth anatomy model 10 as illustrated in FIGS. 1, 2 and 4, and as described above, will now be described.

The demonstrator explains (using the tooth anatomy model 10 to illustrate the various features) that dentin hypersensitivity occurs when dentin becomes exposed and tubules are open at the dentin surface. Gingival recession is the primary way dentin is exposed in the cervical region of the tooth. Once the root is exposed, the protective layer of cementum is easily removed, resulting in open dentin tubules. Based on Brännströms's Hydrodynamic Theory, dentin hypersensitivity is caused by movement of fluid in open dentin tubules. Heat, cold, air and pressure can cause this rapid movement of fluid in open dentin tubules. Each of these stimuli produces a movement or disturbance of fluid in the dentin tubule. This change in fluid flow causes a pressure change within the dentin tubule, which activates the interdental nerves causing a signal that is interpreted as pain.

The demonstrator then rubs ice on the surface 60 of the paint layer 46 on the tooth anatomy model, over the area containing the thermal sensor 34. The application of ice to the surface 60 activates the thermal sensor 34 (as the channels 48 allow the temperature change at the exterior of the model to be communicated to the thermal sensor 34 beneath the paint layer 46) and causes the thermal sensor 34, controller and second relay switch 44 to activate the LEDs 38 in the tooth pulp cavity 16 to flash on and off, and to activate the buzzer to make a buzzing noise. The flashing LEDs 38 indicate sensitized nerves, and the buzzer simulates a cry of pain. The demonstrator explains that this illustrates that thermal stimuli, such as cold temperatures, trigger hypersensitivity.

The demonstrator then blows hot air (from, for example, a hairdryer) onto the surface 60 of the paint layer 46 on the tooth anatomy model, over the area containing the air pressure sensor 36 (differential pressure switch). The blowing of hot air activates the differential pressure switch 36 (as the channels 48 allow the air pressure change at the exterior of the model to be communicated to the differential pressure switch 36 beneath the paint layer 46) and causes it to activate the LEDs 38 in the tooth pulp cavity 16 to flash on and off, and to activate the buzzer to make a buzzing noise. The demonstrator explains that this illustrates that a change in air pressure can also trigger hypersensitivity. The demonstrator also explains that the heat can also trigger hypersensitivity.

The demonstrator then explains that certain specially-formulated toothpastes can block the dentinal tubules, thereby preventing stimuli such as heat, cold and change in air pressure from exerting pressure on the dentinal tubule fluid, and therefore preventing such pressure from being perceived in nerve endings 30 (thus reducing or eliminating the pain caused by dentinal hypersensitivity).

The demonstrator illustrates this by applying the toothpaste to the exposed surface 60 of paint layer 46 on the tooth anatomy model over the area containing the thermal sensor 34 and the air pressure sensor 36. The demonstrator then again applies ice to the toothpaste-coated exposed surface 60, over the area containing the thermal sensor 34. As the toothpaste has created a barrier on the surface 60 of the paint layer 46 so that the thermal sensor 34 is no longer in communication with the air outside the tooth anatomy model 10 (due to the channels 48 being blocked by the toothpaste), the thermal sensor 34 does not sense a change in temperature. The thermal sensor 34 and controller 50 therefore do not activate the second relay switch 44, so the LEDs 38 are not illuminated and the buzzer does not sound. This simulates the reduction or elimination of the pain of dentinal hypersensitivity caused by cold temperature stimuli, upon application of the specially-formulated toothpaste.

The demonstrator then again blows hot air (for example, from a hairdryer) onto the surface 60 of the paint layer 46 on the tooth anatomy model over the area containing the air pressure sensor 36 (differential pressure switch). As the toothpaste has created a barrier on the surface 60 of the paint layer 46 so that the differential pressure switch 36 is no longer in communication with the air outside the tooth anatomy model 10 (due to the channels 48 being blocked by the toothpaste), the differential pressure switch 36 does not sense a change in air pressure. The differential pressure switch 36 is not activated, therefore the LEDs 38 are not illuminated and the buzzer does not sound.

This simulates the reduction or elimination of the pain of dentinal hypersensitivity caused by air pressure stimuli and heat stimuli, upon application of the specially-formulated toothpaste,

In another embodiment, the above method is carried out using tooth model 10 as illustrated in FIG. 3 (which also comprises a paint layer 46 with channels 48, as illustrated in FIG. 4), so as to illustrate that both the heat and the air pressure of the hot air can trigger hypersensitivity, as illustrated by the illumination of both LEDs 38 in the area of the model representing the tooth pulp cavity (which LEDs are illuminated when the thermal sensor senses a temperature of 28° C. or greater) and LED 40, located on the portion representing tooth enamel (which LED is illuminated when the differential pressure switch 36 senses a change in pressure), upon blowing of the hot air onto the surface 60 of the paint layer 46.

As those skilled in the art will appreciate, numerous changes and modifications may be made to the embodiments described herein without departing from the spirit of the invention, it is intended that all such variations fall within the scope of the appended claims.

We claim:

1. A tooth anatomy model comprising:
a first layer representing tooth dentin, said first layer being made of a first material; and
a sensor system associated with a surface of the first layer, which system is adapted to sense at least one of temperature and air pressure.

2. The tooth anatomy model of claim 1, wherein the first material is a cellular foam, a thermoplastic material, a blown polystyrene, a fiber-reinforced plastic, or a combination thereof.

3-6. (canceled)

7. The tooth anatomy model of claim 1, wherein the sensor system is positioned on the surface of the first layer.

8. The tooth anatomy model of claim 1, further comprising a second layer covering the sensor system and the surface of the first layer, wherein the second layer is made of a second material and comprises channels extending from the sensor system to a surface of the second layer.

9. (canceled)

10. The tooth anatomy model of claim 8, wherein the second layer has a thickness of from 0.5 mm to 5 mm.

11. (canceled)

12. The tooth anatomy model of claim 1, wherein the sensor system comprises at least one thermal sensor.

13. The tooth anatomy model of claim 1, wherein the sensor system comprises at least one air pressure sensor.

14. The tooth anatomy model of claim 1, further comprising at least one signal generator for generating at least one signal selected from an audio signal and a visual signal, wherein the sensor system is adapted to activate the at least one signal generator upon sensing a change in temperature or air pressure.

15. The tooth anatomy model of claim 14, wherein the sensor system comprises at least one thermal sensor which is adapted to activate the at least one signal generator upon sensing a temperature of below about 23° C.

16-17. (canceled)

18. The tooth anatomy model of claim 15, wherein the sensor system comprises at least one thermal sensor which is adapted to activate the at least one signal generator upon sensing a temperature of above about 28° C.

19-20. (canceled)

21. The tooth anatomy model of claim 14, wherein the signal generator comprises at least one light source.

22. The tooth anatomy model of claim 21, wherein the at least one light source comprises at least one LED.

23. The tooth anatomy model of claim 14, wherein the signal generator comprises at least one audio source.

24. (canceled)

25. The tooth anatomy model of claim 14, wherein the signal generator comprises at least one light source which is positioned in a portion of the tooth anatomy model which represents a tooth pulp cavity.

26. (canceled)

27. The tooth anatomy model of claim 25, wherein the sensor system is adapted to activate the signal generator so as to activate the at least one light source positioned in the portion of the tooth anatomy model representing the tooth pulp cavity upon sensing a change in temperature.

28. The tooth anatomy model of claim 27, wherein the sensor system is adapted to activate the signal generator so as to activate the at least one light source positioned in the portion of the tooth anatomy model representing the tooth pulp cavity upon sensing a change in air pressure.

29. The tooth anatomy model of claim 27, wherein the signal generator further comprises a light source positioned on a portion of the tooth anatomy model which represents tooth enamel, and wherein the sensor system is adapted to activate the signal generator so as to activate the at least one light source positioned on the portion of the tooth anatomy model representing tooth enamel upon sensing a change in air pressure.

30-40. (canceled)

41. A method of demonstrating tooth hypersensitivity using a tooth anatomy model, the method comprising:
contacting a first layer representing tooth dentin with at least one stimulus selected from a heat stimulus and an air pressure stimulus,
wherein the tooth anatomy model is adapted to sense the at least one stimulus and to provide at least one signal selected from an audio signal and a visual signal upon sensing of the at least one stimulus.

42-46. (canceled)

47. The method of claim 41, further comprising the steps of:
applying an oral care composition to the first layer representing tooth dentin;
thereafter, contacting the first layer representing tooth dentin with at least one stimulus selected from a heat stimulus and an air pressure stimulus,
wherein the oral care composition prevents the tooth anatomy model from sensing the at least one stimulus.

48. The method of claim 47, wherein a second layer covers the first layer, wherein the second layer is made of a second material and comprises channels extending from the first layer to a surface of the second layer.

49-51. (canceled)

52. The method of claim 48, wherein the method further comprises the steps of:
applying an oral care composition to the second layer;
thereafter, contacting the second layer with at least one stimulus selected from a heat stimulus and an air pressure stimulus,
wherein the oral care composition prevents the other anatomy model from sensing the at least one stimulus.

53-83. (canceled)
